(19) United States
(12) Patent Application Publication
(10) Pub. No.: US 2023/0119950 A1
(43) Pub. Date: Apr. 20, 2023

(54) SYSTEM AND METHOD FOR PROVIDING AUDIO AND IMAGE DATA

(71) Applicants: Eriz Gonzales De Zarate Lopez, Vitoria-Gasteiz (ES); Mohammad Aladham, Dubai (AE); Manmohan Singh Balbir Singh, Limassol (CY)

(72) Inventors: Eriz Gonzales De Zarate Lopez, Vitoria-Gasteiz (ES); Mohammad Aladham, Dubai (AE); Manmohan Singh Balbir Singh, Limassol (CY)

(21) Appl. No.: 17/968,993

(22) Filed: Oct. 19, 2022

Related U.S. Application Data
(60) Provisional application No. 63/257,179, filed on Oct. 19, 2021.

(51) Int. Cl. G06F 16/438; G06F 7/08

(52) U.S. Cl. CPC G06F 16/438; G06F 7/08

(57) ABSTRACT

The present disclosure generally relates to a system and method for providing audio and image data. The system and method may receive blurbs from users that include audio and image data. The exemplary disclosed system and method may prioritize or push a given blurb based on consumption by other users. The exemplary disclosed system and method may further prioritize or push a given blurb based on an aggregate metric based on consumption and engagement by other users.

### CONTINUITY DATA

This application claims priority to U.S. Provisional Patent Application No. 63/257,179 filed on Oct. 19, 2021, which is hereby incorporated by reference.

### FIELD OF THE INVENTION

The present disclosure is directed to a system and method for providing data, and more particularly, to a system and method for providing audio and image data.

### BACKGROUND OF THE DISCLOSURE

Conventional systems that involve receiving submitted data from users for evaluation and use on a platform typically prioritize such data for display to users based primarily on engagement. Also, conventional systems typically focus on submitted video data. However, conventional systems typically do not effectively account for consumption of audio data by users in prioritizing data for presentation to users.

The exemplary disclosed system and method of the present disclosure is directed to overcoming one or more of the shortcomings set forth above and/or other deficiencies in existing technology.

### SUMMARY OF THE INVENTION

It therefore is an object of the invention to provide system and method that effectively accounts for consumption of audio data by users in prioritizing data for presentation to users.

The present disclosure generally relates to methods for providing audio and image data. The methods may receive blurbs from users that include audio and image data. The exemplary disclosed system and method may prioritize or push a given blurb based on consumption by other users. The exemplary disclosed system and method may further prioritize or push a given blurb based on an aggregate metric based on consumption and engagement by other users.

Another aspect of the present disclosure also generally relates to a non-transitory computer readable medium encoded with computer executable instructions that when executed by the computer results providing audio and image data comprising one or more computer readable storage media and instructions collectively stored on the one or more computer readable storage media, the instructions comprising: receiving a blurb that includes audio and image data; processing the blurb to gather data used in updating a sorting score; determining the sorting score for the blurb data based on consumption by other users; sorting the blurb data; prioritizing the blurb data based on the sorting score and a priority metric; and displaying blurb data.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 illustrates an exemplary process of at least some exemplary embodiments of the present disclosure;

FIG. 2 illustrates an exemplary process of at least some exemplary embodiments of the present disclosure;

FIG. 3 illustrates an exemplary process of at least some exemplary embodiments of the present disclosure;

FIG. 4 is a schematic illustration of an exemplary computing device, in accordance with at least some exemplary embodiments of the present disclosure;

FIG. 5 is a schematic illustration of an exemplary network, in accordance with at least some exemplary embodiments of the present disclosure; and

FIG. 6 is a schematic illustration of an exemplary network, in accordance with at least some exemplary embodiments of the present disclosure.

### DETAILED DESCRIPTION AND INDUSTRIAL APPLICABILITY

The exemplary disclosed system and method may provide a platform for users to submit audio data (e.g., and image data) that those users have created to be listened to by other system users. For example, the exemplary disclosed system and method may provide a platform for the user to submit audio data (e.g., an audio blurb) that may be a musical performance or other audio data that may be listened to, enjoyed, and evaluated by other users.

The exemplary disclosed system and method may include a computational algorithm that may categorize and score the audio data (e.g., blurbs) that may appear in (e.g., be displayed by) an API operated on a user device of a user. For example, graphical elements representing an audio blurb may appear in a given section (e.g., a user's Feed page) of an application programming interface (API) operated and displayed to a user using a user device such as, for example, the exemplary disclosed user device or user interface described herein.

The exemplary disclosed computational algorithms may deliver high quality content to users. For example, the content (e.g., blurbs) that the API (e.g., a Feed page) displays may include content that the user or other users (e.g., following users or users being followed) post. The algorithms may deliver that content (e.g., blurb) in a way that generates effective engagement for the users for example as described below. The exemplary disclosed algorithm may evaluate (e.g., score) the blurbs of following users based on several criteria and data as described herein, so that the displayed blurbs may be more engaging as compared to proposing the blurbs by merely displaying the blurbs in chronological order.

The exemplary disclosed blurb may be any suitable data such as audio and/or visual data. For example, the blurb may include audio data (e.g., a musical piece of any desired length such as between about 10 seconds and about 180 seconds or any other desired length). The blurb may also include visual data such as data of an image or a plurality of images (e.g., a GIF). In at least some exemplary embodiments, the exemplary disclosed blurb may not include video data (e.g., may not be a video).

The exemplary disclosed computation algorithms may take into account several data features of a blurb (e.g., an audio clip generated by an API user to be posted to the API) to generate a final score and use that score to propose blurbs in a Feed screen of other users of the API. The exemplary disclosed computational algorithms may utilize (e.g., take and process data features) from each of the blurbs submitted or posted to the API by users. The exemplary disclosed algorithms (e.g., based on the exemplary disclosed mathematical formula included in the algorithms) may determine (e.g., create) a score that may then be used to list and sort the blurbs that may be shown to a given user in that user's API (e.g., Feed page). For example, during an operation of the exemplary disclosed algorithms, once a blurb is created, a scheduled script may be launched and may retrieve data from the blurbs (e.g., update blurbs) from a suitable database for example similar to the exemplary disclosed databases described herein. The updated blurb features and new interactions (e.g., from other users) may then be used to determine or generate a score based on the exemplary disclosed mathematical formula. That score may then be used to sort the blurbs into an order or configuration in which the blurbs may be displayed to a given user via the API. For example, as described herein, the exemplary disclosed system and method may utilize the exemplary disclosed programming language code and databases in performing the algorithms. Also, for example, the exemplary disclosed system and method may utilize machine learning operations for example as described herein during some or substantially all steps of the exemplary disclosed algorithms.

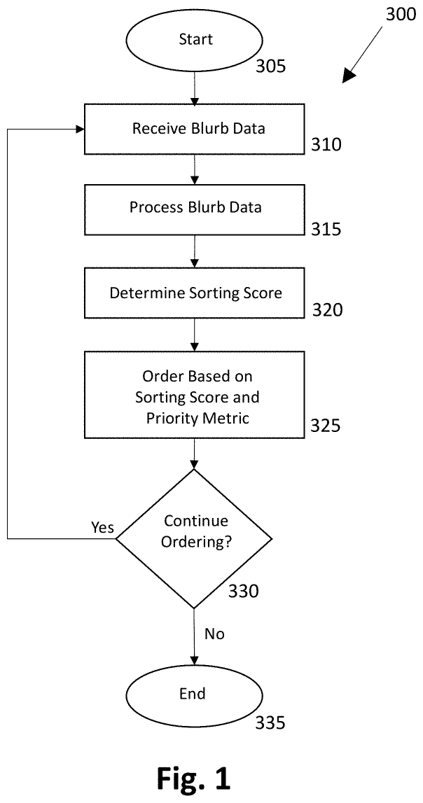

FIG. 1 illustrates an exemplary disclosed process (e.g., algorithm) of the exemplary disclosed system and method (e.g., a “feed” algorithm). The exemplary disclosed algorithm (e.g., algorithm model) may be used in a Feed page of an API (e.g., that may operate using, iOS, Android, and/or any other suitable operating system). The algorithm model may utilize and process data of blurbs of other users that a given user follows. In at least some exemplary embodiments, the exemplary disclosed algorithm may order (e.g., initially order) the blurbs by the most recently posted blurbs. Priority may be given to blurbs that are not seen by the user (e.g., blurbs that have not yet been displayed to the user by the system).

As illustrated in FIG. 1, process 300 begins at step 305. At step 310, the exemplary disclosed system may receive blurb data. The exemplary disclosed system may receive new blurb data and updates provided (e.g., submitted or posted) or transferred by users. The exemplary disclosed system may process the blurb data to gather data to be used in updating a score for example as described below. For example, as described herein, the exemplary disclosed system and method may utilize the exemplary disclosed programming language code and database in performing the algorithm.

At step 315, the exemplary disclosed system may process blurb data (e.g., process the blurb data in the model). The exemplary disclosed system and method may process the blurb data features and input the blurb data features into the exemplary disclosed model so that a score may be calculated. For example, the exemplary disclosed system and method may determine the score to quantitatively evaluate the blurb. The exemplary disclosed system and method may also generate additional models (e.g., another model) as desired.

At step 320, the exemplary disclosed system may determine (e.g., and output) a sorting score. The exemplary disclosed system may obtain (e.g., to be provided from the exemplary disclosed database) a float number and assign the float number to blurb data (e.g., a blurbId). The exemplary disclosed system may also change an output formula as desired.

At step 325, the exemplary disclosed system may determine an order of blurbs based on the sorting score determined at step 320 and a priority metric (e.g., a predetermined priority metric). The exemplary disclosed system may utilize the float number obtained and assigned at step 320.

At step 330, the exemplary disclosed system may determine whether or not to continue ordering. If ordering is to be continued, process 300 may return to step 310. Steps 310 through 330 may be repeated for any desired number of iterations. If ordering is not to be continued, process 300 ends at step 335.

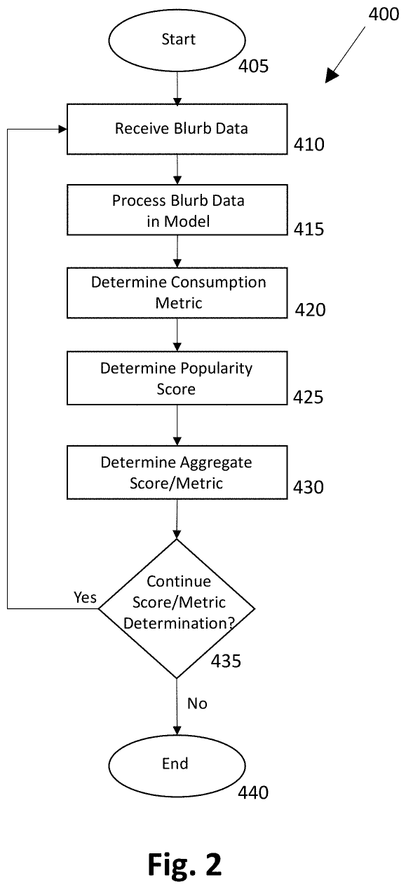

FIG. 2 illustrates another exemplary disclosed process (e.g., algorithm) of the exemplary disclosed system and method (e.g., a “stage” algorithm) that may be displayed to the user via the exemplary disclosed API (e.g., that may operate using, iOS, Android, and/or any other suitable operating system). As illustrated in FIG. 2, process 400 may include determining a popularity score based on an operation of the exemplary disclosed algorithm, which may include a mathematical formula including a weighted sum of some of the exemplary disclosed variables. These exemplary disclosed variables may be blurb interaction variables based on user behavior and actions using the exemplary disclosed API. For example, the exemplary disclosed variables may include user likes, user comments, user shares, and/or viewed percentage (e.g., of views by users).

As illustrated in FIG. 2 and in at least some exemplary embodiments, process 400 may include retrieving some or substantially all public profile blurbs from a previous predetermined time period (e.g., the last three days). Also for example, a longer time frame may be used (e.g., or the system may add a fallback).

As illustrated in FIG. 2 and in at least some exemplary embodiments, the exemplary disclosed system and method may evaluate a Blurb Popularity Score. Each blurb may be shown (e.g., displayed via the exemplary disclosed API) to 95% (e.g., or any other desired fraction or portion) of users (e.g., of total, randomized users). By way of example, a given user may be the creator of a 100 second blurb that the user may transfer to the system. The blurb may appear in a given API section (e.g., a “Stage” page) of a given amount of users (e.g., 95% random users of a total database of users). Users may consume (e.g., listen to) the blurb. An amount of consumption from different users may be combined to comprise aggregate consumption (e.g., during step 420). For example, a first user may consume (e.g., listen to) the blurb for a first amount of time (e.g., X seconds), a second user may consume (e.g., listen to) the blurb for a second amount of time (e.g., Y seconds), and so on (e.g., additional users may listen). The exemplary disclosed system and method may utilize a consumption metric (e.g., an accumulated passive consumption metric) such as, for example, 10*X %+10*Y%=Z%.

Process 400 may also include using a sub-algorithm to determine which users may be active (e.g., by creating an activeness metric) within a given day. For example, a timestamp of a given user's last interaction on the application may be used to determine an activeness metric. In at least some exemplary embodiments, a maximum time may be set (e.g., 24 hours) for displaying the blurb to users and seeking user interaction. The exemplary disclosed system and method may then calculate the Popularity Metric (e.g., popularity score for example at step 425) based on engagement interactions (e.g., based on user likes, user comments, user shares, and/or any other suitable indicators or user actions).

Process 400 may also include combining (e.g., summing) the accumulated consumption metric and the popularity metric to create an aggregate metric (e.g., one final Engagement Metric) to sort the blurbs (e.g., at step 430). The engagement metric may be updated (e.g., continuously updated) as new user interactions occur and are identified by the system. Process 400 may be used to provide a section (e.g., “The Stage”) of the exemplary disclosed API that may be suited to a given user's interests. For example based on hashtags (e.g., or any other suitable criteria), the exemplary disclosed system and method may maintain the most recent interests (e.g., the last three main interests) that a user interacts with (e.g., identifying how many blurbs that user consumes with those hashtags or criteria), so that the exemplary disclosed system may display a given percentage of those blurbs to that user (e.g., sorted by the Engagement Metric determined at step 430).

As illustrated in FIG. 2, process 400 begins at step 405. At step 410, the exemplary disclosed system may receive blurb data. The exemplary disclosed system may receive new blurb data and updates provided (e.g., submitted or posted) or transferred by users. The exemplary disclosed system may process the blurb data to gather data to be used in updating a score for example as described herein. For example as described herein, the exemplary disclosed system and method may utilize the exemplary disclosed programming language code and database in performing the algorithm.

At step 415, the exemplary disclosed system may process blurb data (e.g., process the blurb data in the model). The exemplary disclosed system and method may process the blurb data features and input the blurb data features into the exemplary disclosed model so that a score may be calculated.

At step 420, the exemplary disclosed system may determine (e.g., and output) the exemplary disclosed consumption metric (e.g., the accumulated passive consumption metric for example as described above). The exemplary disclosed system may obtain (e.g., be provided from the exemplary disclosed database) a float number and assign the float number to blurb data (e.g., a blurbId). The exemplary disclosed system may also change an output formula as desired.

At step 425, the exemplary disclosed system may determine (e.g., and output) the exemplary disclosed popularity score for example as described above. The exemplary disclosed system may utilize the float number obtained and assigned at step 420.

At step 430, the exemplary disclosed system may determine (e.g., and output) the exemplary disclosed aggregate metric (e.g., the accumulated consumption metric and popularity metric) for example as described above. The exemplary disclosed system may utilize the float number obtained and assigned at step 420.

At step 435, the exemplary disclosed system may determine whether or not to continue determining the exemplary disclosed scores. If the determination is to be continued, process 400 may return to step 410. Steps 410 through 435 may be repeated for any desired number of iterations. If determination is not to be continued, process 400 ends at step 440.

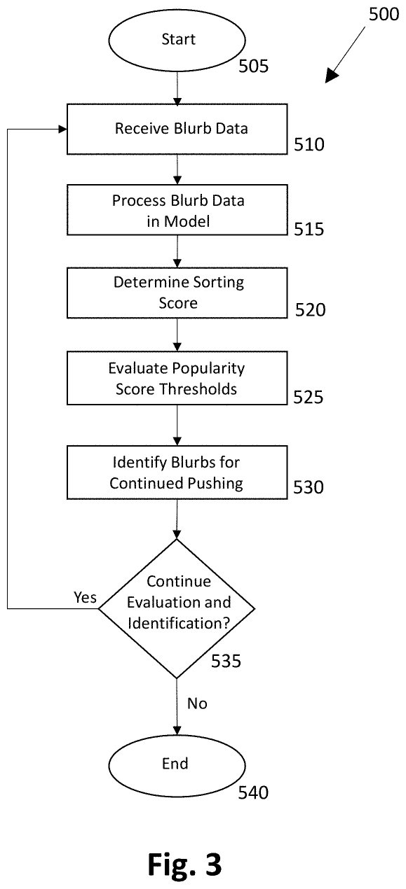

FIG. 3 illustrates another exemplary disclosed process (e.g., algorithm) of the exemplary disclosed system and method (e.g., a “spotlight” algorithm) that may be displayed to the user via the exemplary disclosed API (e.g., that may operate using, iOS, Android, and/or any other suitable operating system). As illustrated in FIG. 3, process 500 may be displayed in a section (e.g., “Spotlight page”) of the exemplary disclosed API to the user.

As illustrated in FIG. 3 and in at least some exemplary embodiments, the exemplary disclosed system and method may include retrieving some or substantially all blurbs from the exemplary disclosed API section described regarding FIG. 2 (e.g., the “Stage tab”). The exemplary disclosed system and method may identify blurbs as candidates for processing in process 500 (e.g., “Spotlight” candidates) based on any suitable criteria such as, for example, blurbs that may have attained a 100% Accumulated Passive Consumption Metric (e.g., or any other desired amount) and that have a 25% Follower Interaction Engagement Metric (e.g., or any other desired amount) for example as described herein. The exemplary disclosed system and method may calculate an interaction count number by applying the 25% (e.g., or any other desired percentage) to a follower count of the blurb creator (e.g., determine a sorting score for example at step 520). By way of example, if a user creates and submits a blurb and the user has 10 followers, the user's blurb would be considered for the “Spotlight” section if three users (e.g., 25% or greater) interact. The interacting users may be followers or may not be followers. If in a subsequent iteration of operation that threshold or condition is not reached, then the blurb may be removed from the “Spotlight” section

The exemplary disclosed system and method may sort the blurbs (e.g., on the “Spotlight” section) based on the Popularity Metric (e.g., at step 525), which may be determined (e.g., calculated) based on any suitable criteria such as engagement interactions (e.g., like, comment, or share). The blurbs may be shown to some or substantially all users in the database (e.g., all users of the system). If a blurb is consumed (e.g., listened to) by a user, the blurb may be moved or passed to the last position of the list or array (e.g., on the “Spotlight” section), and the second blurb may move to the first or top position. In at least some exemplary embodiments, the blurbs may be displayed to users in a carousel arrangement, in which users may move or spin the carousel to view blurbs. The exemplary disclosed system and method may reevaluate the exemplary disclosed popularity metric at any desired time period (e.g., each hour or any other desired interval). In at least some exemplary embodiments, if the exemplary disclosed popularity metric for a given blurb has not been increased in any desired time period (e.g., the last 3 hourly lookups or any other desired time duration), the blurb may be removed from Spotlight and the data metrics of the blurb may be reset. For example, the blurb may be moved to the “Stage” section for example as described above regarding process 400 (e.g., moved to the last position of the Stage). Also for example, the blurb may be returned to the process of FIG. 1 (e.g., the blurb may again be provided or pushed to random users such as to 100 random users or any other suitable number of users).

As illustrated in FIG. 3, process 500 begins at step 505. At step 510, the exemplary disclosed system may receive blurb data. The exemplary disclosed system may receive new blurb data and updates provided (e.g., submitted or posted) or transferred by users. The exemplary disclosed system may process the blurb data to gather data to be used in updating a score for example as described herein. For example as described herein, the exemplary disclosed system and method may utilize the exemplary disclosed programming language code and database in performing the algorithm.

At step 515, the exemplary disclosed system may process blurb data (e.g., process the blurb data in the model). The exemplary disclosed system and method may process the blurb data features and input the blurb data features into the exemplary disclosed model so that a score may be calculated.

At step 520, the exemplary disclosed system may determine (e.g., and output) the exemplary disclosed sorting score for example as described above. The exemplary disclosed system may obtain (e.g., be provided from the exemplary disclosed database) a float number and assign the float number to blurb data (e.g., a blurbId). The exemplary disclosed system may also change an output formula as desired.

At step 525, the exemplary disclosed system may evaluate (e.g., check) the exemplary disclosed popularity score for example as described above and evaluate the exemplary disclosed thresholds. The exemplary disclosed system may utilize the float number obtained and assigned at step 520.

At step 530, the exemplary disclosed system may determine, identify, and/or sort blurbs for continued prioritization (e.g., pushing) and/or blurbs that will no longer be prioritized (e.g., pushed) for example as described above. The exemplary disclosed system may prioritize (e.g., push) blurbs with Popularity Scores above the exemplary disclosed threshold and not prioritize (e.g., not push) blurbs with Popularity Scores below the exemplary disclosed threshold for example as described above.

At step 535, the exemplary disclosed system may determine whether or not to continue evaluation and identification. If the evaluation and identification are to be continued, process 500 may return to step 510. Steps 510 through 535 may be repeated for any desired number of iterations. If evaluation and identification are not to be continued, process 500 ends at step 540.

The exemplary disclosed system and method may be used in any suitable application for use in an API. For example, the exemplary disclosed system and method may be used in any suitable application for prioritizing data for presentation to users. The exemplary disclosed system and method may be used in any suitable application for providing a platform for presenting audio and image data to users.

The exemplary disclosed system and method may provide an efficient and effective technique for prioritizing audio data to be presented to users. The exemplary disclosed system and method may also account for consumption of audio data by users in prioritizing data for presentation to users.

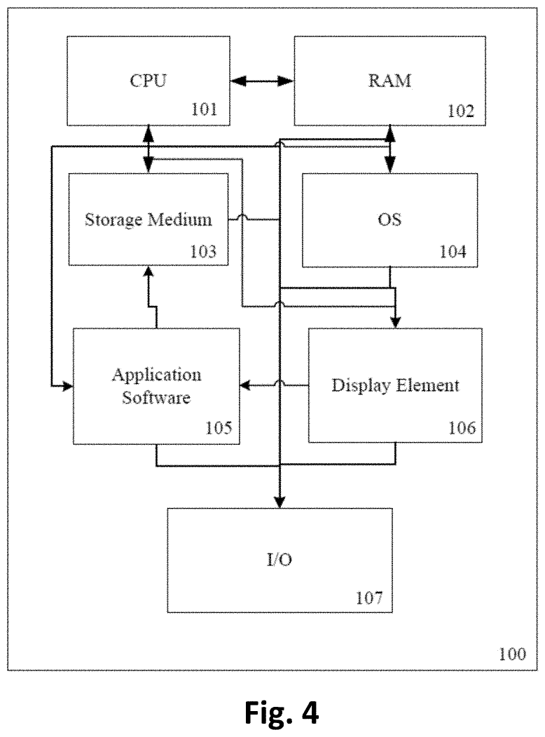

An illustrative representation of a computing device appropriate for use with embodiments of the system of the present disclosure is shown in FIG. 4. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

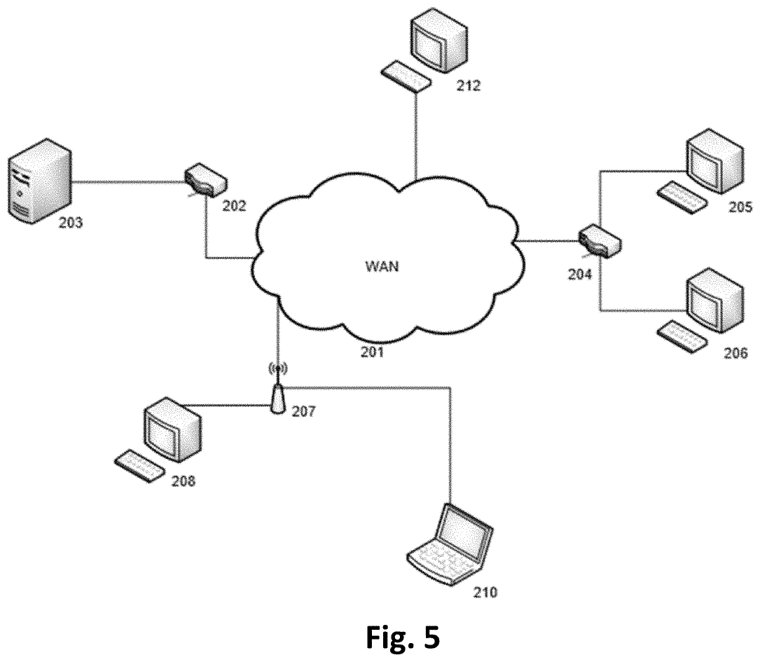

Various examples of such general-purpose multi-unit computer networks suitable for embodiments of the disclosure, their typical configuration and many standardized communication links are well known to one skilled in the art, as explained in more detail and illustrated by FIG. 5, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 5, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 5, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

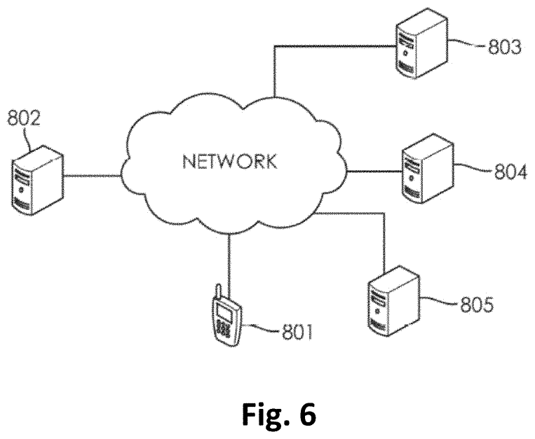

Turning now to FIG. 6, a continued schematic overview of a cloud-based system in accordance with an embodiment of the present invention is shown. In FIG. 6, the cloud-based system is shown as it may interact with users and other third party networks or APIs (e.g., APIs associated with the exemplary disclosed E-Ink displays). For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. The data store may also be a non-relational database. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A method for providing audio and image data comprising:
receiving a blurb that includes audio and image data;
processing the blurb to gather data used in updating a sorting score;
determining the sorting score for the blurb data based on consumption by other users;
sorting the blurb data;
prioritizing the blurb data based on the sorting score and a priority metric; and
displaying blurb data.

2. The method of claim 1, wherein the processing of blurb data includes processing blurb data within one or more models.

3. The method of claim 1, wherein the determining a score for blurb data includes obtaining a float number and assigning the float number to the blurb data.

4. The method of claim 3, wherein the determining a score includes a weighted sum of at least one of user likes, user comments, user shares, and user views.

5. The method of claim 2, wherein the method of providing audio and image data includes determining a consumption metric.

6. The method of claim 4, wherein the method of providing audio and image data includes determining a popularity score.

7. The method of claim 5, wherein the method of providing audio and image data includes determining an aggregate score.

8. The method of claim 6, wherein the method of providing audio and image data includes determining a sorting score.

9. The method of claim 7, wherein the method of providing audio and image data includes evaluating popularity score thresholds.

10. The method of claim 8, wherein the method of providing audio and image data includes identifying blurbs for continued pushing.

11. A non-transitory computer readable medium encoded with computer executable instructions that when executed by the computer results providing audio and image data comprising:
One or more computer readable storage media and instructions collectively stored on the one or more computer readable storage media, the instructions comprising:
receiving a blurb that includes audio and image data;
processing the blurb to gather data used in updating a sorting score;
determining the sorting score for the blurb data based on consumption by other users;
sorting the blurb data;
prioritizing the blurb data based on the sorting score and a priority metric; and
displaying blurb data.

12. The non-transitory computer readable medium encoded with computer executable instructions of claim 11, wherein the processing of blurb data includes processing blurb data within one or more models.

13. The non-transitory computer readable medium encoded with computer executable instructions of claim 11, wherein the determining a score for blurb data includes obtaining a float number and assigning the float number to the blurb data.

14. The non-transitory computer readable medium encoded with computer executable instructions of claim 13, wherein the determining a score includes a weighted sum of at least one of user likes, user comments, user shares, and user views.

15. The non-transitory computer readable medium encoded with computer executable instructions of claim 12, wherein the providing of audio and image data includes determining a consumption metric.

16. The non-transitory computer readable medium encoded with computer executable instructions of claim 14, wherein the providing of audio and image data includes determining a popularity score.

17. The non-transitory computer readable medium encoded with computer executable instructions of claim 15, wherein the providing of audio and image data includes determining an aggregate score.

18. The non-transitory computer readable medium encoded with computer executable instructions of claim 16, wherein the providing of audio and image data includes determining a sorting score.

19. The non-transitory computer readable medium encoded with computer executable instructions of claim 17, wherein the providing of audio and image data includes evaluating popularity score thresholds.

20. The non-transitory computer readable medium encoded with computer executable instructions of claim 18, wherein the providing of audio and image data includes identifying blurbs for continued pushing.
